(19) United States
(12) Patent Application Publication
(10) Pub. No.: US 2015/0039471 A1
(43) Pub. Date: Feb. 5, 2015

(54) System for Verifying Source of Food and Providing Customized Information with Respect Thereto

(71) Applicants: Trace and Trust, Inc., Davis, CA (US); Trace and Trust, Inc., Davis, CA (US); Trace and Trust, Inc., Davis, CA (US)

(72) Inventors: Michael Emile Clayton, Davis, CA (US); Gaspar Catanzaro, North Kingstown, RI (US); Calvin B. Ward, Castro Valley, CA (US)

(21) Appl. No.: 13/957,197

(22) Filed: Aug. 1, 2013

(51) Int. Cl. G06Q 30/06

(52) U.S. Cl. CPC G06Q 30/0623
USPC 705/26.61

(57) ABSTRACT

A method for operating a computer system to provide information about a product to a customer is disclosed. The method includes receiving a login request identifying a specific business establishment and the customer from a customer device that is remote from the data processing system, and initiating a session for the customer between the computer and the customer device. When the computer receives a product code identifying a product in the business establishment that originates at a producer of the product, the computer sends information to the customer about the product, the information being verified by an organization independent of the producer of the product and the business establishment. The login request can be generated by the customer device interacting with a display at the business establishment, the display identifying the business establishment and optionally a location within the business establishment at which the customer is located.

### BACKGROUND OF THE INVENTION

Various problems in the food supply chain have made consumers increasingly more concerned with knowing the source of the food being purchased and its route to their dinner table. As a result, consumers are favoring restaurants and other providers that sell sustainable, healthy and/or locally grown or caught food items. Restaurants and other providers are responding by claiming that the food is sustainable, healthy, locally grown, locally caught by local fisherman, etc. However, merely providing statements to that effect on a menu or food display at a market is often not sufficient to assure the consumer that the food is, in fact, as represented and that the food has been transported and stored in an appropriate manner, particularly in view of the continuing reports of misrepresented food.

While the new emphasis on locally produced goods has increased the market opportunities that are available to the local producers, these producers are still heavily dependent on distributors and restaurants for their increased marketing opportunities. The small producers are typically not well equipped to market their products to the general public or to other distributors or final point of sale establishments.

Final point of sale establishments such as restaurant chains or market chains are also poorly equipped for doing business with a number of different small producers in each area in which the chain has a store. The local establishments in the chain must be able to ensure a sufficient supply of product that meets its needs from the small suppliers. To guard against distribution interruptions, multiple suppliers are needed for each location. The transaction costs of setting up these arrangements, defining the product and information specifications needed and ensuring that the products and related information continue to meet the chain's standards are a significant barrier to being able to use and effectively market the small suppliers.

Small local establishments are often better positioned to identify local suppliers. However, local establishments lack the economy of scale for automating the operations of the establishment. In addition, the local establishments must also be able to assure the customers that the food being sold is as represented and has not been mishandled between the producer and the restaurant or other provider. The local establishments also need an efficient, consistent and standard process for displaying and marketing products received from producers with different attributes.

### SUMMARY OF THE INVENTION

The present invention includes a method for operating a data processing system to provide information about a product to a customer. The method includes receiving a login request identifying a specific business establishment and the customer from a customer device that is remote from the data processing system, and initiating a session for the customer between the data processing system and the customer device. When the data processing system receives a product code identifying a product in the business establishment that originates at a producer of the product, the data processing system sends information to the customer about the product, the information being verified by an organization independent of the producer of the product and the business establishment.

In one aspect of the invention, the login request is generated by the customer device scanning a display at the business establishment, the display identifying the business establishment. The login request can also identify one of a plurality of locations within the business establishment at which the customer is located.

In another aspect of the invention, a message is sent to the business establishment requesting a server to go to the one of the plurality of locations in response to a request service message being sent from the customer device.

In a still further aspect of the invention, the product includes information about the processing history of the product. The information about the processing history may include a date on which the product left the producer and information about the producer of the product. In addition, the information may include information about business establishments at which products from the producer can be purchased.

In a still further aspect of the invention, the data processing system stores information identifying the customer's interest in the product.

In a further aspect of the invention, the business establishment includes a restaurant, and the product code identifies a product on a menu in the restaurant. The product code is generated when the customer scans a menu item code associated with an item on the menu. The login request is generated when the customer scans a login display on a table at which the customer is seated, the login request identifying the table at which the customer is seated. The customer can summon a server by sending a message to the data processing system. The customer can also order items from the menu by scanning menu item codes with the customer device. The data processing system can also provide information about a server who serves the table at which the customer is seated.

In another aspect of the invention, the data processing system provides the customer with an opportunity to designate a voluntary payment for the producer as well as a gratuity for the server.

In a still further aspect of the invention, the data processing system offers the customer an opportunity to join an organization associated with the data processing system if the customer is not already a member. The customer can receive a discount on the products purchased if the customer is a member of an organization associated with the data processing system. The discount can depend on past purchases by the customer or be determined by the store at the time of the purchase.

### BRIEF DESCRIPTION OF THE DRAWINGS

FIG. 1 illustrates various features of the present invention.

### DETAILED DESCRIPTION OF THE PREFERRED EMBODIMENTS OF THE INVENTION

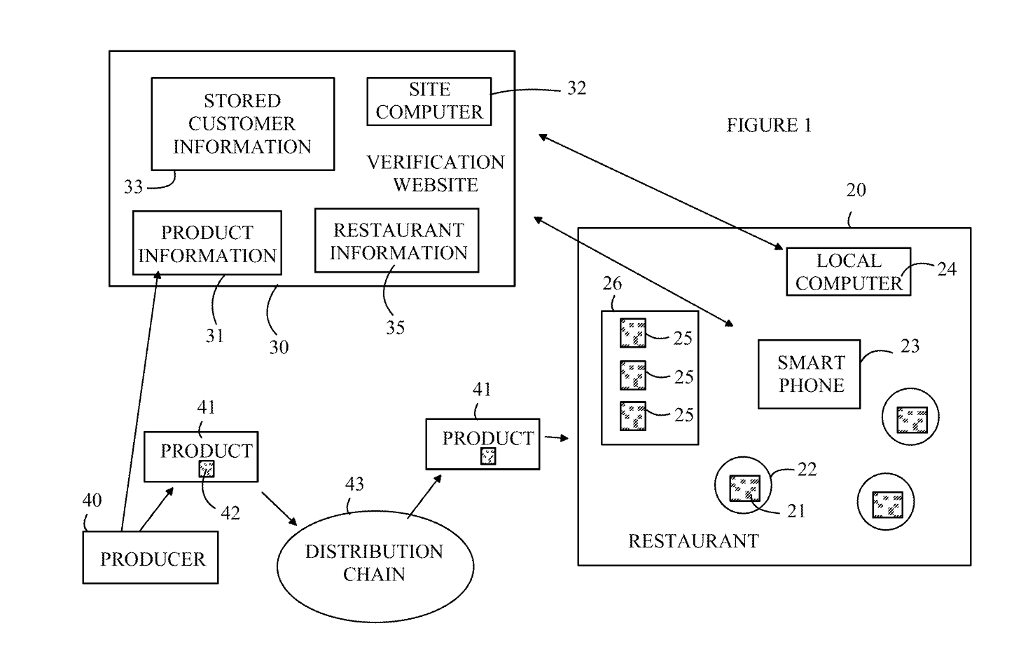

The manner in which the present invention provides its advantages can be more easily understood with reference to a system for providing information to a customer at a restaurant. Refer now to FIG. 1, which illustrates various features of the present invention. Restaurant 20 features menu items that include products such as produce, meats, seafood, etc. from a number of local producers and/or small producers. Information about that produce is provided by a third party verification website 30 that stores the information 31 about the producer and the particular batch of product that is being served by the restaurant. Each table 22 in the restaurant has a login display 21 that includes a code that can be scanned using an application on a smart phone 23 or similar device. The code identifies both the restaurant and the table within the restaurant at which the customer is seated. For the purposes of this discussion, this display will be referred to as the login display. The third party verification website 30 will be referred to as the verification website in the following discussion. For the purposes of this discussion, a “website” is defined to be any server that generates information for a client routine that generates a display on a user's mobile device.

When the customer scans login display 21, the customer is logged into a data processing system such as computer 32 at verification website 30. The verification website also includes information 35 about the restaurant. The verification website is also connected to a data processing system such as computer 24 in the restaurant. Verification website 30 informs restaurant computer 24 that the customer has logged into verification website 30 and provides restaurant computer 24 with the table at which the customer is sitting. Verification website 30 then provides the customer with a list of options that are displayed on the customer's smart phone 23. Among this list of options is an option to summon a server to the table.

For the purposes of this example, it will be assumed that the restaurant has printed menus 26 that are provided by the server or a host when the customer is seated. These menus include menu codes 25 that can also be scanned using the customer's smart phone 23. The menu codes are associated with various items on printed menu 26. By scanning a particular code, the customer can access information 31 about that item that is stored in verification website 30. The information returned can be customized for the restaurant and/or customer if the customer is a member of the verification website organization. Hence, the same code can be used at a number of different establishments and return different results since the results can also depend on the particular restaurant and customer. The information can include the source of the item, a description of the particular dish in which the item is used, and information about the processing history of the product that went into the item.

The source information can include a description of the producer and background material about the producer's specialties. In the case of farmed products, for example, the producer can explain the producer's methods of farming and how the producer practices environmentally sound farming practices. In the case of seafood products, the information can include information on the producer's fishing methods and locations in which the seafood is harvested. The information can also include information about certification bodies, non-governmental organizations or membership organizations with which the producer collaborates.

The information can also include information about other places of business that provide products that originate with the producer. This type of information will be referred to as producer advertising in the following discussion. The customer knows that he or she can trust the truthfulness of the information because it is provided by verification website 30. The verification website can provide various levels of verification from merely ensuring that the information has been approved by the producer to actually verifying the accuracy of the information.

The processing history information is optional information that tracks the history of a particular shipment of product that was produced and shipped by the producer 40. Each batch of product 41 leaving producer 40 is marked with a code 42 that identifies the producer and the date of harvest or the date on which the product left producer 40. This code is scanned by producer 40 and the results uploaded to verification website 30 at the time of shipment. The code can be included in a label that also has environmental and other sensors that track the temperature history, chemical environments encountered and geographic path of the product in transit. Typically, product 41 enters a distribution chain 43 prior to being delivered to restaurant 20. When the shipment arrives at the restaurant, the restaurant also scans the code on the product and uploads that scan to verification website 30. Hence, the customer can see that the product left the producer on a given date and was not subject to conditions that would cause spoilage en route. Accordingly, the customer can be assured of the freshness of the product that is being consumed. Similarly, restaurant 20 can also verify the history of the product to check on the performance of the various intermediate product handlers in the supply chain.

It should be noted that the particular batch of product could be tested at one or more points along the route from the producer to the restaurant. Information about that batch of product resulting from such testing is forwarded to the verification website and stored with product information 31. The testing could include tests for contaminants such as bacteria. In addition, the tests could include DNA testing to ensure that the product is as represented, i.e., horse meat is not included in the hamburger.

In one aspect of the invention, the customer can also order a particular menu item by scanning a code associated with that menu item on the menu. In this aspect of the invention, the menu items are also stored at the verification website for the restaurant in question. If the particular menu item requires additional information such as the manner in which the item is to be cooked, the verification website application presents the customer with a list of choices that are selectable on the customer's smart phone.

It should be noted that the customers can still order in the conventional manner through a server. In one aspect of the invention, the server uses a tablet or similar computing device to place the order for the customer by scanning the codes or using a menu on the tablet.

In one aspect of the invention, the customer is a member of an organization that provides the verification website. When the customer logs into the verification website from the restaurant, the customer also logs into that customer's account at the verification website. If the customer is not a member of the organization, the customer is offered an opportunity to sign up for membership. The organization can provide discounts or other incentives to encourage the customer to become a member. For customers who are members, the verification website can track the customer's dining preferences and collect data 33 from the customer on specific items ordered from the menu.

In one aspect of the invention, the customer's bill is entered on the verification website together with any gratuities that the customer desires to add to the bill. The customer has the option of splitting the gratuities between a plurality of entities that participated in the customer's dining experience including the server and the producers of various components of the meal. In addition to the information provided about the producers, the verification website can also provide personal information about the server and other individuals at the restaurant who were involved in the customer's dining experience. In this aspect of the invention, the verification website uses the information on the table at which the customer is seated and a database showing the server at that table and the selected others who have participated to present the customer with an opportunity to view additional information about these individuals. The verification website allows the customer to provide separate gratuities for each person who participated in the dining process and processes the gratuities and returns each producer's share to that producer.

The verification website organization can also provide customized payments to various entities in the supply chain by distributing payments collected from the restaurant to various members of the supply chain based on the relationship between the entity and the overall supply chain. The verification website organization can collect a payment from the restaurant that is to be split in predetermined manner by the verification website organization and one or more entities in the supply chain. The splitting of the gratuities described above is an example of such a process. These payments can be viewed as bonuses that are distributed by the verification website. The payments provide a mechanism for various entities in the supply chain to change their pricing for particular participants without changing the overall pricing structures and pre-existing contracts within the supply chain.

The verification organization is positioned to perform two functions in the supply chain. The first function is to verify the producer and product. As noted above, the level of verification can vary depending on the needs of the other entities in the supply chain. At one extreme, the verification organization can determine that the producer is as represented. For example, in the case of a fisherman, the producer has a boat and catches fish. At the other extreme, the verification organization can go out with the fisherman and verify the fishing methods and processing of the fish prior to entering the supply chain.

The second function is to provide marketing information for the producer. Since the verification organization is already dealing with the producer in its verification role, it is well positioned to develop information that can be used by other entities in the supply chain to sell the products at a premium price; for example, the above-described information that is elicited by scanning a code on a menu.

Hence, the verification organization creates value that is realized at various points in the distribution chain. Accordingly, the verification organization can demand payments at various points in the distribution chain for the value generated. The sums that are redistributed can originate within the supply chain as well as from the end point of the supply chain, i.e., the entity that sells to the consumer. For example, a distributor may wish to pay a bonus to a particular supplier without increasing the sums normally paid for the product in question in a manner that would change the pricing system that is in place for the product in question. The bonus can reflect the value added by the verification website organization in finding and verifying a particular producer or developing marketing or other materials for that producer. The bonus to the producer reflects the unique nature of the producer's product over the standard commodity product handled by the distributor.

The verification organization is advantageously placed to provide such payment collection and redistribution. The verification organization already distributes the split gratuity from the restaurant to the producer. In addition, the verification organization ideally collects fees from the point in the distribution at which the organization provides value.

As noted above, in another aspect of the invention, the verification website stores data 33 about the customer if the customer is a member of the verification website organization. As will be explained in more detail below, the customer can provide various levels of security with respect to the sharing of this data with the restaurant or other entities involved with the verification website such as the producers. If the customer has enabled sharing with the restaurant, the customer's dining preferences and other data about the customer is forwarded to the restaurant's computer 24.

For example, the customer can indicate the level of service desired by the customer from the serving staff. Some customers prefer not to be interrupted by the staff unless the customer has summoned the server. In this case, the server will not make the usual trip to the table asking the customer to comment on the customer's satisfaction with the meal.

In addition, the customer dining preferences can include information on how the customer likes his or her food, preferences as to salad dressings, etc. The server can then merely ask the customer if the customer wants the meat cooked as indicated or differently. For customers with specific dietary requirements such as avoiding an ingredient that causes an allergic reaction in the customer, the customer preferences can be used to eliminate items from the menu presented to the customer that have the ingredient in question. In addition, the customer preferences can be used by the restaurant to modify certain dishes to match the customer's preferences and note those modifications on the menu provided to the customer. Hence, a customer with a peanut allergy could receive a menu in which a dish that normally uses peanuts is made without the peanuts and the menu item emphasizes this alteration.

The personal information may include information about the customer's family, birthdays, etc. This information allows the establishment to present the customer with more personalized service in a manner that is analogous to that provided in a small restaurant to a longtime customer of that establishment.

The customization of the dining experience for the customer can be provided independent of the information on the products and producers intended for the customer. In this aspect of the invention, the customer's data and the restaurant's data such as the current menu and products thereon are combined to provide a customized experience for the customer without endangering the customer's privacy and control of the customer data. The third party website provides the customization by combining the relevant customer information with the data from the restaurant to provide a customized experience for the customer. As noted above, that experience can include a customized menu, personal information about the server or chef if the customer information indicates that the customer wants such information. The information that is sent to restaurant may include a birthday or anniversary and a discount to be applied or special item offered.

In one aspect of the invention, the information sent to the restaurant is not in a form that the restaurant can utilize for the restaurant's future advertising or other exploitation. For example, the customer's email address will not be sent to the restaurant unless the customer specifically authorizes such transfer. Since the key customer information is held at the third party website, the customer only needs assurance that the third party website will not use the information for unauthorized purposes, and hence, violations of customer privacy can be reduced and tracked.

In another aspect of the invention, communications between the restaurant or other members of the supply chain and the customer are filtered through the third party website to prevent customer information, such as the customer's normal email address, from being divulged to an outside entity. A member of the website organization is given an email account at a website controlled by that organization. An entity that wishes to send advertising or other communications to the customer based on the customer's stored preferences, sends the information to the third party website to be forwarded to the customer if that information matches the preferences stored by the customer. Similarly, customer responses are sent through the third party website to protect the customer's privacy and other email accounts. If the customer finds that a particular entity is sending information that does not really match the customer's preferences, the customer can block further communications by that entity.

In this manner, the customer, not the advertising entity controls the access to the customer. An advertiser that wants to send an advertisement to customers with a particular interest, sends that advertisement to the website. The website then matches the advertisement to the customer using keywords in the advertisement and the customer preferences.

The above-described embodiments assume that only one member of the dining party is a member of the verification website organization. However, it is advantageous to have each member of the dining party be a member of the verification website organization. This will allow the restaurant to provide individualized care for each member. In addition, increasing the membership of the verification website organization is an important goal, as part of the verification website organization's profits depend on the number of members in that organization.

In one aspect of the invention, each member of the verification website organization who is in the dining party also scans the code at the login display. If the person who attempts to sign in is not a member, the verification website gives that person the opportunity to sign up. To encourage new members, the person signing up and one of the members at the table are given rewards by the verification website organization. In addition, the server can be given awards if the customers sign up or purchase particular items from the menu.

In another aspect of the invention, the customer(s) paying the bill may charge the bill to a credit or debit card that is on file at the verification website organization and/or use credits at the verification website organization to offset all or part of the bill. The verification website organization then forwards the restaurant's share of the bill to the restaurant after retaining any fees associated with a transaction through the verification website organization. This aspect of the invention is particularly advantageous if the customer is new to the restaurant and has security concerns about the establishment having the customer's credit or debit card information. It is also useful in reducing the time needed for the customer to pay the bill, since the customer does not need to summon a server, provide the credit card to the server, and then wait for the card and bill to be returned.

As noted above, the present invention also provides a platform for producer advertising. When a patron scans the code on the menu related to the producer of the product, the customer can view more detailed information about the producer. Since the customer often has spare time during the dining experience, the customer is a “captured” audience for this type of producer advertising. The producer advertising can include direct offers to the customer that are independent of the restaurant. The offers can include discounts on future purchases of the producer's products, an opportunity to participate in a game that has a price provided by the producer, typically involving the producer or the producer's products. For example, the winner could get to spend time at the producer's farm or go on a fishing trip with the producer in the case of a seafood provider.

The producer advertising can also include an opportunity for the verification website organization customer to obtain additional information from the producer including other establishments at which the producer's products can be found. For example, a local produce grower can provide information on farmers markets at which the producer sells products, websites from which the customer can order the products or local markets that carry the products.

While the present invention helps to assure the customer that the food being consumed is wholesome, there are always events in which food contamination occurs. As noted above, the verification organization can provide independent testing of the products, and hence, reduce the chance that the customer will be exposed to a contaminant. However, there will be situations in which a customer becomes ill. In one aspect of the invention, the verification website organization stores the details of the customer's orders for a period of time sufficient to provide notification to the customer if a product recall is initiated. If contamination of a particular product is discovered because the contamination resulted in illness, the verification website organization can notify all verification website organization customers who consumed the contaminated food.

In yet another aspect of the invention, the customers are asked to review the meals at check-out time. An appropriate questionnaire can be downloaded on the customer's smart phone. This type of review is more reliable than the typical reviews provided by various third party sites, since the customer is asked to perform the review rather than the customer deciding later to review the restaurant by submitting a review to the review site. The later type of review typically provides reviews from customers who are very motivated to review the restaurant. This sample overly represents customers who are very unhappy for some reason or who are plants by the restaurant or a competing restaurant. In addition, these questionnaires can be developed and distributed through the system to the customer not only by the restaurant but also by the producer or distributor, providing important insights into customer reactions on products, restaurant buyers, marketing campaigns, etc.

The present invention can also use information about the customer's other reviews in grading the restaurant. If a customer reviews a number of restaurants, the current review can be normalized by the other reviews to provide a more objective level of satisfaction. In addition, the other reviews submitted by the customer can be used to eliminate fake reviews or one time experiences. A restaurant that has a loyal following is more likely to be a good restaurant than one that does not. This information is valuable, for example, to producers selling to the restaurants, to the restaurants in assessing their performance and to customers in making decisions about which restaurants to visit.

In addition, the amount of the gratuity left by the customers can be used to gauge the customer's satisfaction with the dining experience. If the customer leaves more than the customer's usual percentage as a tip, the customer is more likely to have had an above average dining experience.

The gratuity provided to the other members of the dining experience such as the producer of a particular ingredient, e.g., the locally grown produce, can also be used to identify customers who would be receptive to more information about the producer or other producers of such ingredients.

Since the customer enters data directly into the verification website organization website, the customer does not have to worry about the restaurant or the staff seeing the reviews or split in gratuities. The staff can be provided with a summary of the reviews covering a particular period. In addition, the ratings given for various aspects of the meal such as the service can be used to evaluate the staff, chef, etc.

The utilization of the customer's smart phone or other similar personal mobile device has a number of additional advantages. First, it relieves the restaurant of providing some form of computer such as a tablet at each table. While embodiments that utilize a common tablet at each table could be constructed, the restaurant provided tablets do not have the same level of security and privacy as the customer's own smart phone or tablet. The customer knows that the data being entered on his or her smart phone is not being copied by any system at the restaurant. In addition, the cost of providing a tablet at every table is substantial, particularly if the tablet is easily handed from customer to customer, as loss due to theft becomes a concern.

Second, a tablet that is used by everyone who eats at the table in question poses health issues unless it is cleaned after each customer. Customers who are particularly concerned about the spread of disease organisms often prefer not having to use an item that is used by many unknown people. Further, the large number of cleaning operations on the tablet screens or protective covers increases the maintenance and/or decreases the lifetime of the tablet.

The above-described embodiments of the present invention have been directed to restaurants; however, embodiments of the present invention can be advantageously used in other environments. For example, the present invention could be utilized in a store such as a supermarket by a shopper to verify the source and obtain information about various products sold in that store. The store would provide scannable codes adjacent to each product or the supplier could provide the codes on the products themselves. The codes can include the production lot associated with the product. The consumer would scan a login display at the store that would identify the location of the store and log the consumer onto the verification website. The verification website would then transmit the information about the product and its source to the consumer. Since the verification website knows both the product code and the particular business at which the consumer is shopping, the information sent to the consumer can be customized to emphasize the features that business establishment wishes to emphasize. In addition, if the customer is a member of the verification website organization, information about the customer's preferences can be used to further customize the information.

If the consumer chooses to purchase the product, the consumer can so indicate on the consumer's smart phone. The verification website organization would then store information about the purchase including the production lot in the consumer's history. To encourage the consumer to use this system, the verification website could download a coupon for that product to the consumer's smart phone. The consumer could then present the coupon at checkout to receive the discount. Since the coupon is not generated until the time of selection by the consumer, the store can use such coupons to help move merchandise that is becoming overstocked or has been sitting too long on the shelves. The store administrator can sign into the verification website with a store code and then scan particular codes of items to be discounted and indicate the amount of the discount to be issued to a subsequent consumer.

In the above-described embodiments, the customer location was determined by the code that was scanned by the login code that was scanned by the customer. In some cases, the positioning system on the customer's smart phone can provide additional information that is useful when the customer is not near a login code display. For example, assume that a customer wishes to locate a nearby restaurant or other store that satisfies certain criteria specified by the customer. The customer can log into the verification website and indicate the customer's criteria. The criteria can be part of the customer's profile at verification website organization or inputted in the particular session initiated by the customer. The verification website can use the customer's smart phone location to prioritize the responses to the customer's query. In addition, the verification website can indicate if any of the stores has a current special and provide a coupon for that special.

The stores that subscribe to the verification website organization can upload specials that are valid for some short period of time so that a customer can be enticed by those specials. For example, a restaurant that has a slow night could upload a special for customers who come into the restaurant within some specified time period. A customer in the area who is looking for a restaurant of a particular type would then be given the opportunity to book a table at a discount if the customer arrives within the specified time period. Producers could upload similar direct-to-customer specials or wait staff incentives to increase sales of particular products at particular times. For example, a hog farmer may have seen fewer sales than anticipated of fresh pork; in order to stimulate sales to allow for him to slaughter live hogs at a desired weight, he could put incentives in the system for restaurants and restaurant wait staff to prioritize sales of his existing inventory. Similarly, a commercial fisherperson may be catching a significant amount of ‘underutilized species’ (healthy stock) with limited market value. The fisherperson could put similar incentives (e.g., contest allowing one lucky winner a trip on the boat after recording their purchase of the product through the system).

It should be noted that an incentive, in general, can involve a guaranteed payment or benefit of some type or a chance to win an even larger benefit or payment. Hence, a patron who tips the producer could win a chance to get a reward worth many times that tip for the patron. In addition, the reward could extend to the server or others to incentivize those individuals to emphasize particular products or provide exceptional service to members of the verification website organization.

Scannable codes attached to products that cause the scanning device to connect to a website associated with the producer of the products are available on many products. Hence, it is advantageous to be able to use such existing codes in the present invention. In one aspect of the present invention, a member of the verification website organization is provided with a scanning application that reads the code but directs the user to the verification website. The verification website then uses the code to access data about that product or the producer of that product that is stored on the verification website.

In another aspect of the invention, members of the verification website organization can set the level of information sharing about that member's preferences. Various levels of information exchange can include the member's desire to have the restaurant or store know the members preferences and willingness to receive advertising. Different levels of privacy can be associated with different stores. In addition, the type of information that can be given to specific stores can be customized for each store.

The above-described embodiments assume that a restaurant patron is given a printed menu that includes the codes that provide information on the products through the verification website. Embodiments in which the patron has the option of downloading a menu to the patron's smart phone when the patron logs into the verification website by scanning the login display can also be constructed. In this case, the codes can be part of the downloaded menu. If the patron is a member of the verification website organization, the menu can be customized for that patron to reflect preferences stored in the verification website for that patron. For example, a patron who does not eat red meat could be presented with a menu that does not include such items.

The information collected by the verification website is also of interest to the producers of the products sold in the retail establishments. For example, a producer can use the survey information and tipping behavior to determine which restaurants are preparing and presenting the producer's products most successfully. Hence, in one aspect of the invention, the information collected by the verification website with respect to a producer's products is made available to the producer subject to privacy restrictions imposed by the customers.

The above-described embodiments utilize an interaction between a customer device and a code on a menu or login display in which the customer device “scans” the code. Such scanning can be accomplished by the device taking a picture of the code and processing that picture. However, other methods of in which the customer device interacts with the code could be utilized. For example, the codes could include an RF identification tag which is read by the customer device. Accordingly, the term “scan” as used in the present discussion is defined to include any method of interaction between the customer device and the code in which the customer device acquires information contained in the “code”. In addition, “code” is defined to include both optical patterns and other forms of information storage that can be scanned by the customer device.

While the above-described embodiments have emphasized the use of the present invention in systems associated with restaurants, the present invention could also be utilized in other forms of “stores” in which verified information about the products being sold is of value to the customer.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

1. A method for operating a data processing system to provide information about a product to a customer, said method comprising:
causing said data processing system to receive a login request identifying a business establishment and said customer from a customer device that is remote from said data processing system;
causing said data processing system to initiate a session for said customer between said data processing system and said customer device;
causing said data processing system to receive a product code identifying a product in said business establishment that originates at a producer of said product, said producer of said product being different from said business establishment; and
causing said data processing system to send information that has been verified by an organization independent of said producer of said product and stored on said data processing system to said customer, said information providing information about said product.

2. The method of claim 1 wherein said login request is generated by said customer device interacting with a display at said business establishment, said display identifying said business establishment.

3. The method of claim 1 wherein said login request identifies one of a plurality of locations within said business establishment.

4. The method of claim 3 further comprising sending a message to said business establishment requesting a server to go to said one of said plurality of locations in response to a request service message being sent from said customer device, wherein said business establishment is at a location that is remote from said data processing system and is operated by an entity that is different from said business establishment.

5. The method of claim 1 wherein said information about said product includes processing history information related to said product.

6. The method of claim 5 wherein said information about said processing history information includes a date on which said product left said producer.

7. The method of claim 1 wherein said data processing system stores information identifying said customer's interest in said product when said data processing system receives said product code.

8. The method of claim 1 wherein said information about said product comprises information about said producer of said product.

9. The method of claim 8 wherein said information comprises information about other business establishments at which products from said producer can be purchased.

10. The method of claim 1 wherein said business establishment comprises a restaurant and wherein said product code identifies a product on a menu in said restaurant said menu being different from said customer device.

11. The method of claim 10 wherein said product code is generated when said customer device interacts with a menu item code associated with an item on said menu.

12. The method of claim 10 wherein said login request is generated when said customer device interacts with a login display that is separate from said customer device on a table at which said customer is seated, said login request identifying said table.

13. The method of claim 12 wherein said data processing system provides information about a server who serves said table.

14. The method of claim 10 wherein said customer is provided with an opportunity to designate a payment for said producer.

15. The method of claim 14 further comprising causing said data processing system to distribute said payment to said producer.

16. The method of claim 10 wherein said product is provided by a distribution chain and wherein said organization collects a payment from an entity in said distribution chain and distributes part of said payment to another entity in said distribution chain.

17. The method of claim 10 wherein said customer can summon a server by sending a message to said data processing system, wherein said business establishment is at a location that is remote from said data processing system and is operated by an entity that is different from said business establishment.

18. The method of claim 10 wherein said customer can order items from said menu by causing said customer device to interact with menu item codes.

19. The method of claim 1 wherein said data processing system offers said customer an opportunity to join an organization associated with said data processing system when said data processing system initiates said session.

20. The method of claim 1 wherein said customer receives a discount on said product if said customer is a member of an organization associated with said data processing system.

21. The method of claim 20 wherein said discount depends on past purchases by said customer.

22. The method of claim 10 wherein said customer receives a discount on said product if said customer is a member of an organization associated with said data processing system and wherein said discount is determined by said restaurant.

23. The method of claim 20 wherein said discount is determined by said producer.

24. The method of claim 1 further comprising providing information about a customer's reaction to said product to said producer.

25. A method for operating a data processing system to customize information provided to a customer, said method comprising:
causing said data processing system to store customer information on said data processing system;
causing said data processing system to receive product information from a supplier of a product;
causing said data processing system to combine said customer information with said product information to provide customer specific information; and
causing said data processing system to transmit said customer specific information to said customer.

26. The method of claim 25 further comprising providing a communication server through which said customer can communicate with said supplier without divulging said customer information.

27. The method of claim 26 further comprising enabling said communication server to send communications to said customer without divulging said customer information and wherein said customer can block said communications from said supplier.

28. The method of claim 25 wherein said supplier is a restaurant and wherein said customer specific information is a list of items that are served by said restaurant that meet criteria contained in said customer information.
